(19) United States
(12) Patent Application Publication
(10) Pub. No.: US 2007/0143246 A1
(43) Pub. Date: Jun. 21, 2007

(54) Method and apparatus for analyzing the effect of different execution parameters on the performance of a database query

(75) Inventors: Robert Joseph Bestgen, Rochester, MN (US); Michael W. Cain, Rochester, MN (US); Shantan Kethireddy, Rochester, MN (US); Michael Donald Pfeifer, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/304,134

(22) Filed: Dec. 15, 2005

(51) Int. Cl. G06F 17/30

(52) U.S. Cl. 707/2

(57) ABSTRACT

A database application re-uses one or more query execution strategies for a given logical query, and saves historical data concerning query execution performance under differing execution parameters. The historical data is analyzed to identify environmental variables and/or imported variables which significantly affect execution performance. Preferably, an auxiliary data structure includes, for each of multiple execution strategies, a respective set of imported and environmental variables and respective average cost measure, such as execution time. An analytical tool compares multiple different strategies to identify imported and/or environmental variables which caused a different strategy to be used, and resultant average cost. Preferably, the tool can also compare variation within the same strategy.

### FIELD OF THE INVENTION

The present invention relates generally to digital data processing, and more particularly to the generation and execution of database queries in a digital computer system.

### BACKGROUND OF THE INVENTION

In the latter half of the twentieth century, there began a phenomenon known as the information revolution. While the information revolution is a historical development broader in scope than any one event or machine, no single device has come to represent the information revolution more than the digital electronic computer. The development of computer systems has surely been a revolution. Each year, computer systems grow faster, store more data, and provide more applications to their users.

A modem computer system typically comprises hardware in the form of one or more central processing units (CPU) for processing instructions, memory for storing instructions and other data, and other supporting hardware necessary to transfer information, communicate with the external world, and so forth. From the standpoint of the computer's hardware, most systems operate in fundamentally the same manner. Processors are capable of performing a limited set of very simple operations, such as arithmetic, logical comparisons, and movement of data from one location to another. But each operation is performed very quickly. Programs which direct a computer to perform massive numbers of these simple operations give the illusion that the computer is doing something sophisticated. What is perceived by the user as a new or improved capability of a computer system is made possible by performing essentially the same set of very simple operations, but doing it much faster. Therefore continuing improvements to computer systems require that these systems be made ever faster.

The overall speed at which a computer system performs day-to-day tasks (also called “throughput”) can be increased by making various improvements to the computer's hardware design, which in one way or another increase the average number of simple operations performed per unit of time. The overall speed of the system can also be increased by making algorithmic improvements to the system design, and particularly, to the design of software executing on the system. Unlike most hardware improvements, many algorithmic improvements to software increase the throughput not by increasing the average number of operations executed per unit time, but by reducing the total number of operations which must be executed to perform a given task.

Complex systems may be used to support a variety of applications, but one common use is the maintenance of large databases, from which information may be obtained. Large databases usually support some form of database query for obtaining information which is extracted from selected database fields and records. Such queries can consume significant system resources, particularly processor resources, and the speed at which queries are performed can have a substantial influence on the overall system throughput.

Conceptually, a database may be viewed as one or more tables of information, each table having a large number of entries (analogous to rows of a table), each entry having multiple respective data fields (analogous to columns of the table). The function of a database query is to find all rows, for which the data in the columns of the row matches some set of parameters defined by the query. A query may be as simple as matching a single column field to a specified value, but is often far more complex, involving multiple field values and logical conditions. A query may also involve multiple tables (referred to as a “join” query), in which the query finds all sets of N rows, one row from each respective one of N tables joined by the query, where the data from the columns of the N rows matches some set of query parameters.

Execution of a query involves retrieving and examining records in the database according to some search strategy. For any given logical query, not all search strategies are equal. Various factors may affect the choice of optimum search strategy and the time or resources required to execute the strategy.

For example, one of the factors affecting query execution is the sequential order in which multiple conditions joined by a logical operator, such as AND or OR, are evaluated. The sequential order of evaluation is significant because the first evaluated condition is evaluated with respect to all the entries in a database table, but a later evaluated condition need only be evaluated with respect to some subset of records which were not eliminated from the determination earlier. Therefore, as a general rule, it is desirable to evaluate those conditions which are most selective (i.e., eliminate the largest number of records from further consideration) first, and to evaluate conditions which are less selective later. Another factor can be the presence of certain auxiliary database structures which may, if appropriately used, provide shortcuts for evaluating a query. One well known type of auxiliary database structure is an index. An index is conceptually a sorting of entries in a database table according to the value of one or more corresponding fields (columns). If a query includes an indexed value as a condition, it may be advantageous to use the index to determine responsive records, rather than examine each record in the applicable table. A well-designed database typically contains a respective index for each field having an ordered value which is likely to be used in queries.

Query execution time or other resource consumed may be affected by any number of factors in addition to those described above. Many logical queries are written to support one or more imported (“host”) variables in the logical conditions of the query. I.e., a variable value is imported into and becomes part of the logical condition. Where significant data skew exists (i.e., the frequency of occurrence of values in a given field varies significantly), the number of records satisfying a query, and the query execution time, can vary substantially with different imported variable values. Additionally, factors or parameters relating to the environment under which the query is executed, as opposed to the logical conditions of the query itself, (referred to herein as “environmental factors”), may affect execution time. For example, the configuration of the system executing the query and resources available to execute the query, restrictions on the order ofjoin operations or the order of evaluation, use of auxiliary data structures, and so forth, can generally be considered environmental factors. Different imported variable values or environmental factors can even affect the choice of a query execution strategy.

To support database queries, large databases typically include a query engine which executes the queries according to some automatically selected search strategy, using the known characteristics of the database and other factors. Some large database applications further have query optimizers which construct search strategies, and save the query and its corresponding search strategy for reuse. In such systems, it may be possible to construct and save multiple different query execution strategies for a single query. Typically, such systems save a certain amount of additional data associated with each query execution strategy. For example, such additional data may include the imported (host) variables and environmental variables for which the query execution strategy is optimized, historical performance data of the execution strategy, and the like. This data is then used by the system to select an appropriate strategy for executing a given instance of the query, and for determining whether to construct a new execution strategy for the given instance.

Although query optimizers can generate different execution strategies for different conditions, it is often difficult to determine or predict the effect of different imported variable values or environmental variables on execution times. In some cases, prior knowledge of the effect of environmental parameters could be used to change these parameters advantageously, either by selecting a different query execution strategy, or by altering some other environmental variable to maximize performance of a given query execution strategy. In other cases, knowledge of the effect of different imported variable values might be useful in understanding data skew or other database characteristics. A need therefore exists, not necessarily recognized, for improved techniques for analyzing and understanding the effect of certain imported and/or environmental variables on execution of a database query.

### SUMMARY OF THE INVENTION

A database application which supports database queries saves and re-uses one or more query execution strategies for a given logical query, and further saves historical data concerning query execution performance under differing execution parameters. An analytical tool uses the saved historical data to identify imported variables and/or environmental variables which caused significantly different execution performance.

In the preferred embodiment, an auxiliary data structure called a “plan cache” includes, with respect to each of multiple query execution strategies, a set of imported variables and environmental variables for which the strategy was originally constructed and average cost measure, such as execution time, for one or more execution instances of the strategy. The imported and environmental variable data is normally used by an optimizer to determine when a new strategy needs to be constructed. An analytical tool compares multiple different strategies for the same logical query to identify imported variables and/or environmental variables which caused a different strategy to be constructed by the query optimizer, and the corresponding results (execution times or other measure of cost). Significant differences are presented to the user. The user may elect to take appropriate action (such as change a specification of an environmental variable), or may use the information to gain further understanding of the database, such as identifying significant data skew. In one variation, differences from environmental variables are identified by comparing strategies for which the logical query contains no imported or “host” variables, or where all such variables are the same or compatible.

In the preferred embodiment, the plan cache further records, with respect to each query execution strategy, the imported and environmental variables corresponding to the N worst (i.e., slowest) executions of the strategy, and the corresponding execution times. Thus, the tool can further compare changes in imported and/or environmental variables which did not cause a different strategy to be constructed, but which nevertheless resulted in significantly worse performance. Such differences can also be presented to the user.

By identifying imported and/or environmental variables and their affect on query execution performance, the analytical tool provides valuable information to a database user which would be difficult and burdensome for the user to generate himself. This information can be used to constrain the environmental conditions under which future queries are executed in order to improve execution efficiency, to determine data skew, or to otherwise further the understanding of the database and identify improved database management techniques.

The details of the present invention, both as to its structure and operation, can best be understood in reference to the accompanying drawings, in which like reference numerals refer to like parts, and in which:

### BRIEF DESCRIPTION OF THE DRAWING

FIG. 1 is a high-level block diagram of the major hardware components of a computer system for executing database queries and analyzing query execution performance under different execution parameters, according to the preferred embodiment of the present invention.

FIG. 2 is a conceptual illustration of the major software components of a computer system for executing database queries and analyzing query execution performance under different execution parameters, according to the preferred embodiment.

FIG. 3 is a conceptual representation of a persistent query object of a plan cache, according to the preferred embodiment.

FIG. 4 is a flow diagram illustrating at a high level the process of executing a database query, according to the preferred embodiment.

FIGS. 5A and 5B (herein collectively referred to as FIG. 5) are a flow diagram showing the process of analyzing historical data to identify the effect of imported variable values and/or environmental parameters on query execution performance, according to the preferred embodiment.

### DETAILED DESCRIPTION OF THE PREFERRED EMBODIMENTS

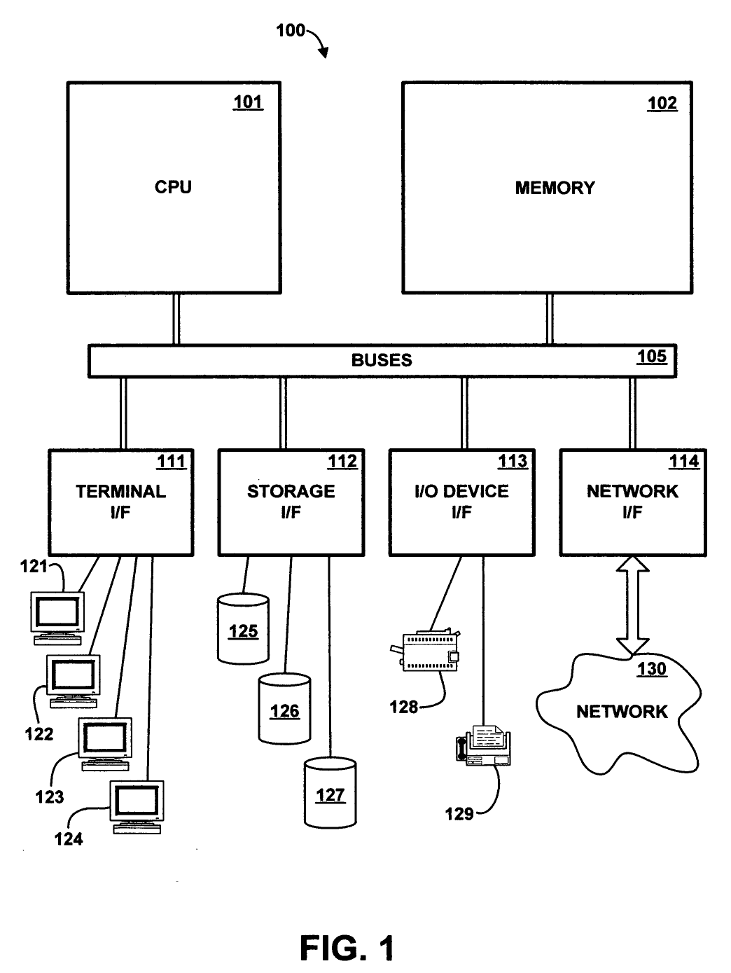

Referring to the Drawing, wherein like numbers denote like parts throughout the several views, FIG. 1 is a high-level representation of the major hardware components of a computer system 100 for use in generating and executing database queries, optimizing query strategies, and analyzing query execution performance for one or more execution strategies under different execution parameters, according to the preferred embodiment of the present invention. CPU 101 is at least one general-purpose programmable processor which executes instructions and processes data from main memory 102. Main memory 102 is preferably a random access memory using any of various memory technologies, in which data is loaded from storage or otherwise for processing by CPU 101.

One or more communications buses 105 provide a data communication path for transferring data among CPU 101, main memory 102 and various I/O interface units 111-114, which may also be known as I/O processors (IOPs) or I/O adapters (IOAs). The I/O interface units support communication with a variety of storage and I/O devices. For example, terminal interface unit 111 supports the attachment of one or more user terminals 121-124. Storage interface unit 112 supports the attachment of one or more direct access storage devices (DASD) 125-127 (which are typically rotating magnetic disk drive storage devices, although they could alternatively be other devices, including arrays of disk drives configured to appear as a single large storage device to a host). I/O device interface unit 113 supports the attachment of any of various other types of I/O devices, such as printer 128 and fax machine 129, it being understood that other or additional types of I/O devices could be used. Network interface 114 supports a connection to an external network 130 for communication with one or more other digital devices. Network 130 may be any of various local or wide area networks known in the art. For example, network 130 may be an Ethernet local area network, or it may be the Internet. Additionally, network interface 114 might support connection to multiple networks.

It should be understood that FIG. 1 is intended to depict the representative major components of system 100 at a high level, that individual components may have greater complexity than represented in FIG. 1, that components other than or in addition to those shown in FIG. 1 may be present, and that the number, type and configuration of such components may vary, and that a large computer system will typically have more components than represented in FIG. 1. Several particular examples of such additional complexity or additional variations are disclosed herein, it being understood that these are by way of example only and are not necessarily the only such variations.

Although only a single CPU 101 is shown for illustrative purposes in FIG. 1, computer system 100 may contain multiple CPUs, as is known in the art. Although main memory 102 is shown in FIG. 1 as a single monolithic entity, memory 102 may in fact be distributed and/or hierarchical, as is known in the art. E.g., memory may exist in multiple levels of caches, and these caches may be further divided by function, so that one cache holds instructions while another holds non-instruction data which is used by the processor or processors. Memory may further be distributed and associated with different CPUs or sets of CPUs, as is known in any of various so-called non-uniform memory access (NUMA) computer architectures. Although communications buses 105 are shown in FIG. 1 as a single entity, in fact communications among various system components is typically accomplished through a complex hierarchy of buses, interfaces, and so forth, in which higher-speed paths are used for communications between CPU 101 and memory 102, and lower speed paths are used for communications with I/O interface units 111-114. Buses 105 may be arranged in any of various forms, such as point-to-point links in hierarchical, star or web configurations, multiple hierarchical buses, parallel and redundant paths, etc. For example, as is known in a NUMA architecture, communications paths are arranged on a nodal basis. Buses may use, e.g., an industry standard PCI bus, or any other appropriate bus technology. While multiple I/O interface units are shown which separate buses 105 from various communications paths running to the various I/O devices, it would alternatively be possible to connect some or all of the I/O devices directly to one or more system buses.

Computer system 100 depicted in FIG. 1 has multiple attached terminals 121-124, such as might be typical of a multi-user “mainframe” computer system. Typically, in such a case the actual number of attached devices is greater than those shown in FIG. 1, although the present invention is not limited to systems of any particular size. User work stations or terminals which access computer system 100 might also be attached to and communicate with system 100 over network 130. Computer system 100 may alternatively be a single-user system, typically containing only a single user display and keyboard input. Furthermore, while the invention herein is described for illustrative purposes as embodied in a single computer system, the present invention could alternatively be implemented using a distributed network of computer systems in communication with one another, in which different functions or steps described herein are performed on different computer systems.

While various system components have been described and shown at a high level, it should be understood that a typical computer system contains many other components not shown, which are not essential to an understanding of the present invention. In the preferred embodiment, computer system 100 is a computer system based on the IBM i/Series™ architecture, it being understood that the present invention could be implemented on other computer systems.

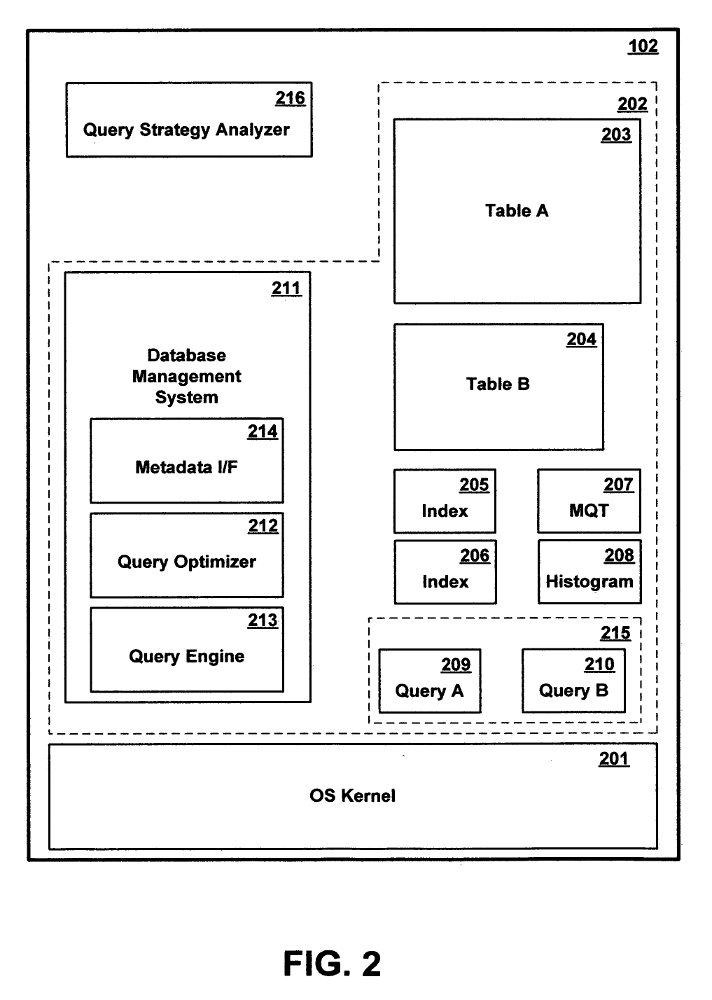

FIG. 2 is a conceptual illustration of the major software components of system 100 in memory 102. Operating system kernel 201 is executable code and state data providing various low-level software functions, such as device interfaces, management of memory pages, management and dispatching of multiple tasks, etc. As is well-known in the art. A structured database 202 contains data which is maintained by computer system 100 and for which the system provides access to one or more users, who may be directly attached to system 100 or may be remote clients who access system 100 through a network using a client/server access protocol.

Database 202 contains one or more tables 203, 204 (of which two are shown in FIG. 2), each having a plurality of entries or records, each entry containing at least one (and usually many) fields, as is well known in the art. Database tables 203, 204 might contain almost any type of data which is provided to users by a computer system. Associated with the database tables are one or more auxiliary data structures 205-210, also sometimes referred to as metadata. Auxiliary data structures characterize the structure of the database and data therein, and are useful in various tasks involved in database management, particularly in executing queries against the database. Examples of auxiliary data structures include database indexes 205-206, materialized query table 207, histogram 208, and saved query objects 209-210, it being understood that other types of metadata may exist.

Database management system 211 provides basic functions for the management of database 202. Database management system 211 may theoretically support an arbitrary number of database tables, which may or may not have related information, although only two tables are shown in FIG. 2. Database management system 211 preferably allows users to perform basic database operations, such as defining a database, altering the definition of the database, creating, editing and removing records in the database, viewing records in the database, defining database indexes, and so forth. Among the functions supported by database management system 211 is the making of queries against data in database tables 203, 204. Query support functions in database management system 211 include query optimizer 212 and query engine 213. In the preferred embodiment, database management system 211 includes a metadata interface 214 having one or more application programming interfaces (APIs) by which external applications can access data in one or more auxiliary data structures 205-210, and particularly can access data in query objects 209-210. Database management system 211 may further contain any of various more advanced database functions. Although database management system 211 is represented in FIG. 2 as an entity separate from operating system kernel 201, it will be understood that in some computer architectures various database management functions are integrated with the operating system.

Query optimizer 212 generates query execution strategies for performing database queries. As is known in the database art, the amount of time or resource required to perform a complex query on a large database can vary greatly, depending on various factors, such as the availability of an index or other auxiliary data structure, the amount of resources required to evaluate each condition, and the expected selectivity (i.e., number of records eliminated from consideration) of the various logical conditions. Optimizer 212 determines an optimal execution strategy according to any optimizing algorithm, now known or hereafter developed, and generates an execution strategy, also known as an “access plan” or “plan”, according to the determination. The execution strategy is a defined series of steps for performing the query, and thus is, in effect, a computer program. The optimizer 212 which generates the execution strategy performs a function analogous to that of a compiler, although the execution strategy data is not necessarily executable-level code. It is, rather, a higher-level series of statements which are interpreted and executed by query engine 213.

A query can be saved as a persistent storage object in memory, and can be written to disk or other storage. Once created by optimizer 212, a query execution strategy can be saved with the query as part of the persistent storage object. The query can be invoked, and a saved query strategy re-used (re-executed), many times. For a given query, it is possible to generate and save one, or optionally multiple, query execution strategies, each optimized for different respective conditions. E.g., where a query contains an imported (“host”) variable in one of its conditions, the value of which is specified at the time the query is executed, different query execution strategies could be used for different values of the imported variable. Different query execution strategies might also be used for different environmental parameters under which the query is to be executed. In addition to saving one or more query execution strategies, certain metadata with respect to each query execution strategy can be saved, such as the conditions for which the strategy was generated and historical data concerning the execution of the strategy.

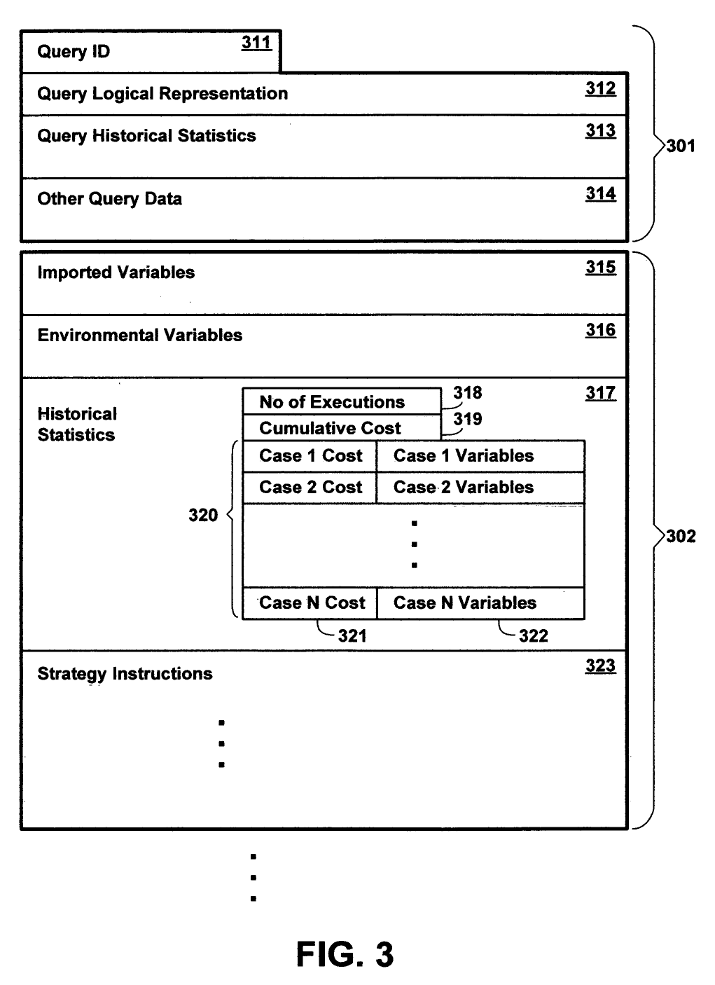

The collection of saved queries, query execution strategies and associated data is loosely referred to as the “plan cache”. FIG. 2 represents plan cache 215, containing persistent storage objects Query A 209 and Query B 210. Query objects are described in further detail herein, with respect to FIG. 3. Although two query objects are represented for illustrative purposes in FIG. 2, it will be understood that the actual number of such entities may vary, that typically a large computer system contains a much larger number of query objects, that each query object may contain or be associated with zero, one, or more than one execution strategies. Although these are referred to herein as “query objects”, the use of the term “object” is not meant to imply that database management system 211 or other components are necessarily programmed using so-called object-oriented programming techniques, or that the query object necessarily has the attributes of an object in an object-oriented programming environment, although it would be possible to implement them using object-oriented programming constructs.

Although one database 202 having two database tables 203, 204, two indexes 205-206, one MQT 207 and one histogram 208 are shown in FIG. 2, the number of such entities may vary, and could be much larger. The computer system may contain multiple databases, each database may contain multiple tables, and each database may have associated with it multiple indexes, MQTs, histograms, or other auxiliary data structures not illustrated. Alternatively, some entities represented in FIG. 2 might not be present in all databases; for example, some databases might not contain materialized query tables or the like. Additionally, database 202 may be logically part of a larger distributed database which is stored on multiple computer systems. Although database management system 211 is represented in FIG. 2 as part of database 202, the database management system, being executable code, is sometimes considered an entity separate from the “database”, i.e., the data.

An external query strategy analytical tool application 216 analyzes the effect of imported and/or environmental variables on query execution by accessing data in plan cache 215 using metadata interface 214. The operation of this analytical tool is described in greater detail herein. In the preferred embodiment, query strategy analyzer 216 is a separate application external to database management system 211, although it could alternatively be a function or set of functions integrated into database management system 211.

In addition to database management system 211 and analytical tool 216, one or more user applications (not shown) may access data in database tables 203, 204 to perform tasks on behalf of one or more users. Such user applications may execute on computer system 100, or may access the database from remote systems. Such user applications may include, e.g., personnel records, accounting, code development and compilation, mail, calendaring, or any of thousands of user applications.

Various software entities are represented in FIG. 2 as being separate entities or contained within other entities. However, it will be understood that this representation is for illustrative purposes only, and that particular modules or data entities could be separate entities, or part of a common module or package of modules. Furthermore, although a certain number and type of software entities are shown in the conceptual representation of FIG. 2, it will be understood that the actual number of such entities may vary, and in particular, that in a complex database server environment, the number and complexity of such entities is typically much larger. Additionally, although software components 202-216 are depicted in FIG. 2 on a single computer system 100 for completeness of the representation, it is not necessarily true that all programs, functions and data will be present on a single computer system or will be performed on a single computer system. For example, query strategy analyzer 216 may be on a separate system from the database; a database may be distributed among multiple computer systems, so that queries against the database are transmitted to remote systems for resolution, and so forth.

While the software components of FIG. 2 are shown conceptually as residing in memory 102, it will be understood that in general the memory of a computer system will be too small to hold all programs and data simultaneously, and that information is typically stored in data storage devices 125-127, comprising one or more mass storage devices such as rotating magnetic disk drives, and that the information is paged into memory by the operating system as required. In particular, database tables 203, 204 are typically much too large to be loaded into memory, and typically only a small portion of the total number of database records is loaded into memory at any one time. The full database 202 is typically recorded in disk storage 125-127. Furthermore, it will be understood that the conceptual representation of FIG. 2 is not meant to imply any particular memory organizational model, and that system 100 might employ a single address space virtual memory, or might employ multiple virtual address spaces which overlap.

FIG. 3 is a conceptual representation of a typical persistent query object 209 of plan cache 215, according to the preferred embodiment. A query object contains a header portion 301, and a variable number of execution strategy blocks 302 (of which one is represented in the example of FIG. 3 for clarity, it being understood that a larger number could be, and often is, present). The header portion contains a query identifier field 311, a query logical representation 312, query historical statistics 313, and additional query data 314. The query logical representation 312 is a representation of the query in a form understandable by the query optimizer 212 and/or query engine 213, from which a query execution strategy can be constructed. Query historical performance statistics 313 include historical performance data concerning previous executions of the query. Preferably, historical statistics includes at least the number of times the query has been executed and a measure of the cumulative “cost” of execution. Cost may be any appropriate measure of the resources used and/or time consumed, such as an interactive response time, a number of CPU cycles, a number of I/O operations, etc, and could be a combination of such factors. There could be multiple “cost” fields representing different respective elements of the “cost” of a query. An average “cost” may be obtained by dividing the cumulative cost by the number of executions. Other historical data, such as cost distributions or histograms, changes in the average cost of execution over time, etc., might also be maintained. Additional query data 314 includes various other data which might be useful to database management system 211 or other applications accessing a query. For example, additional data 314 might include a text description of the query, security and access control information, and so forth. Query historical statistics 313 and additional query data 314 are represented in FIG. 3 as respective single blocks of data for clarity of illustration; however, such additional data will typically comprise multiple fields, some of which may be optional or of variable length, or may reference data in other data structures.

Execution strategy block 302 contains data relating to a particular execution strategy for the query. As is known in the art of database management, the choice of an optimal query execution strategy could depend in numerous factors, including the resources allocated to a particular user or process invoking a query, the values of imported variables within the query, the state of the system, and so forth. Query optimizer 213 can generate, and database manager 211 can save, multiple query execution strategies for a given query, each appropriate for use under a different respective set of conditions. Each execution strategy block 302 corresponds to a respective execution strategy for the query.

In general, an execution strategy block 302 contains a strategy header portion comprising one or more of imported variable conditions 315, environmental variable conditions 316, and historical performance statistics 317 for the corresponding execution strategy; and a body comprising strategy instructions 323.

Imported variable conditions 315, where present, express any conditions on the values of imported variables which are associated with the execution strategy. Generally, each of different execution strategies is a valid algorithm for satisfying the query, and will therefore produce identical sets of records which satisfy the query conditions. But different strategies may be optimized for different imported variable values, and these strategies should not be used when the imported variable values fall outside the range for which the strategy was optimized. Additionally, there are circumstances in which a strategy might be optimized by taking a “shortcut” based on the value of some imported variable. For example, a subset of a database table might be excluded from search based on the value of the imported variable. In such cases, use of the strategy to execute a query having a different imported variable value may actually produce invalid results. Imported variable conditions 315 contain imported variable values for which the strategy is considered “optimal” and/or for which the strategy will produce a valid result.

Environmental variables 316 contain the state of the environmental parameters which were used to initially generate the execution strategy. I.e., when query optimizer 313 initially generated the corresponding strategy, it did so based on certain assumptions about the system environment and other environmental parameters which would govern the execution of the query. These parameters are saved in environmental variables 316. It will be noted that, although the strategy was initially generated based on a certain set of environmental parameters (and therefore optimized to that set of parameters by query optimizer 313), the strategy is not necessarily always executed under the same environmental conditions.

Historical performance statistics 317 includes relevant data expressing historical execution performance of the corresponding execution strategy. Historical statistics 317 could include a variety of relevant data, but in particular, in the preferred embodiment includes the number of times the corresponding strategy has been executed 318 and a measure of the cumulative “cost” of execution 319. Cost may be any appropriate measure of the resources used and/or time consumed, as explained above with respect to query historical statistics 313. Historical statistics further preferably includes data for the N worst case execution instances of the corresponding strategy 320, i.e., the N instances of execution having the highest “cost”, according to the appropriate cost measure. With respect to each such instance, the cost of the corresponding execution instance 321 and the execution parameters (imported variables and environmental parameters) under which the execution instance took place 322 are saved. Historical statistics 317 may include other or additional historical performance data for the strategy.

The strategy block 302 further contains a set of strategy instructions 323 for executing the corresponding strategy. In the preferred embodiment, these are not directly executable code, but are higher-level instructions which are interpreted by the query engine 213 to execute the query. These instructions determine whether or not indexes are used to search the database records and the order in which conditions are evaluated.

Among the functions supported by database management system 211 is the making of queries against data in database 202, which are executed by query engine 213. As is known, queries typically take the form of statements having a defined format, which test records in the database to find matches to some set of logical conditions. Typically, multiple terms, each expressing a logical condition, are connected by logical conjunctives such as “AND” and “OR”. Because database 202 may be very large, having a very large number of records, and a query may be quite complex, involving multiple logical conditions, it can take some time for a query to be executed against the database, i.e., for all the necessary records to be reviewed and to determine which records, if any, match the conditions of the query.

The amount of time required or other measure of cost to perform a complex query on a large database can vary greatly, depending on many factors. Depending on how the data is organized and indexed, and the conditions of the query, conditions may optimally be evaluated in a particular order, and certain auxiliary data structures such as indexes or materialized query tables may be used. The effect of using auxiliary data structures or changing the order of evaluations or joins can be very dramatic. Similarly, different values of an imported variable can cause a large change in the number of responsive records as a result of data skew, and consequent change in the execution time or other cost measure. Often more subtle are the effects of different system configurations and similar environmental parameters on query execution. A single query execution strategy might exhibit varying execution performance under different environmental parameters. Furthermore, either a different imported variable value or different environmental parameter might cause the optimizer to generate a new query execution strategy which his optimized to those execution parameters. The general concept of different imported variables and/or environmental parameters includes both the situation where a single execution strategy exhibits different performance, and where the change in execution parameters causes a different strategy to be selected.

In accordance with the preferred embodiment of the present invention, certain historical data is maintained with respect to query execution strategies, which particularly includes imported variable values and environmental parameters associated with query execution strategies and historical performance. Query strategy analyzer 216 accesses this historical data, and compares changes in performance with the different imported variables and/or environmental parameters to identify the effect of deltas in these execution parameters on performance.

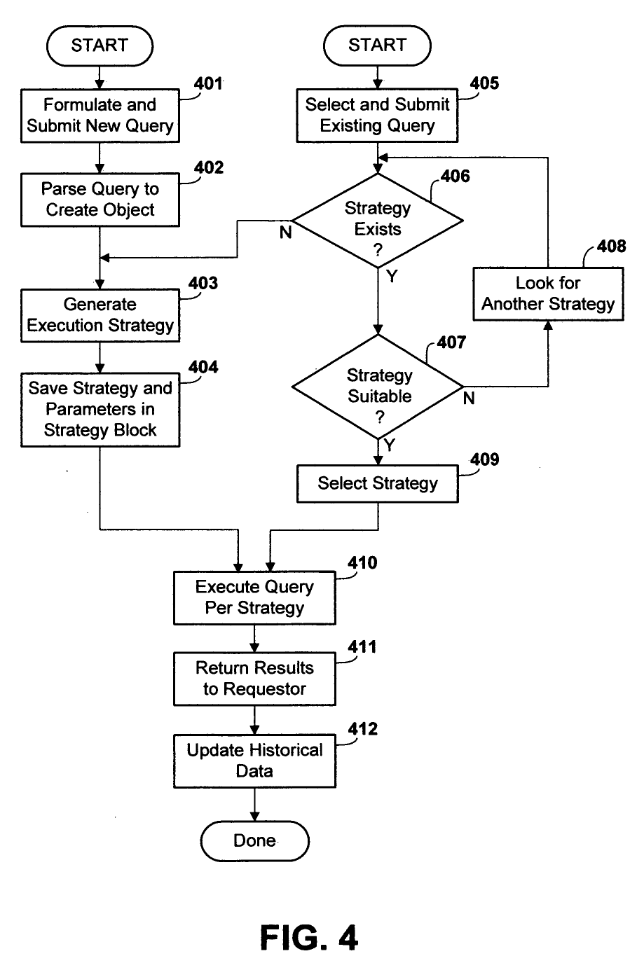

FIG. 4 is a flow diagram illustrating at a high level the process of executing a database query, according to the preferred embodiment. Referring to FIG. 4, a query may be initiated either as a newly defined query, or as a re-used (previously executed and saved) query, as shown by the two paths beginning at blocks 401 and 404, respectively.

For a new query, a requesting user formulates and submits a database query using any of various techniques now known or hereafter developed (step 401). E.g., the database query might be constructed and submitted interactively using a query interface in database management system 211, might be submitted from a separate interactive query application program, or might be embedded in a user application and submitted by a call to the query engine 213 when the user application is executed. A query might be submitted from an application executing on system 100, or might be submitted from a remote application executing on a different computer system. In response to receiving the query, query engine 213 parses the query into logical conditions to generate a query object (step 402), which may be saved for re-use. The query engine invokes optimizer 212 to generate an optimized execution strategy block for the query (step 403). Optimizer 213 generates an optimized execution strategy using the current environmental parameters and values of any imported variables. I.e., the strategy which is generated is optimized for a particular set of imported variables and environmental parameters, and while it may produce valid results for other parameters, it is not necessarily optimized for those conditions. The strategy may be generated using any conventional technique or any technique hereafter developed. The generated strategy is saved as a strategy block 302 in the query object (step 404), the strategy block including the imported variables and environmental parameters for which the strategy was optimized. After generation and saving of a suitable execution strategy at steps 403 and 404, the database management system proceeds to step 410.

Where an existing query is re-used, a requesting user selects the existing query object for re-use and invokes it, using any of various techniques now known or hereafter developed (step 405). E.g., the query might be selected interactively from a menu in database management system 21 1, might be submitted from a separate interactive application program, or might be embedded in a user application and submitted by a call to the query engine 213 when the user application is executed, any of which might be performed from system 100, or from a remote system. Re-using an existing query may require specifying one or more imported variable values and/or environmental variables to be used in execution of the query.

In response to invoking the query, query optimizer 213 determines whether a saved strategy exists in the query object 209 (step 406). If no such strategy exists (the ‘N’ branch from step 406), the optimizer generates one (step 403), as in the case of a new query. If a previously saved execution strategy exists for the query (the ‘Y’ branch from step 406), the optimizer determines whether the saved execution strategy is suitable for use under the imported variable values of the current query instance and the current environmental variables (step 407). This determination may be made using any appropriate technique, now known or hereafter developed, but in general the optimizer accesses the imported variables 315 and environmental parameters 316 associated with the query execution strategy, which were saved when the strategy was initially generated, to determine whether the existing strategy can be re-used for the current imported variables and environmental parameters. If the saved execution strategy is not suitable for use in the current query instance, then the ‘N’ branch is taken from step 407, and the database management system looks for another previously saved execution strategy (step 408), continuing then to step 406. The database management system continues to look for execution strategies (loop at steps 406-408) until a suitable strategy is found (the ‘Y’ branch from step 407) or there are no more strategies (the ‘N’ branch from step 406).

If a suitable execution strategy is found, the ‘Y’ branch is taken from step 407, and the execution strategy is selected (step 409). Where multiple execution strategies are permissible (multiple strategies satisfy their respective logical conditions), the database manager will choose one of these multiple strategies. Such a choice could be based on priorities, or any criteria or technique now known or hereafter developed, or could be arbitrary. After selecting a strategy, the database management system proceeds to step 410.

The query engine is then invoked to execute the query according to the query execution strategy which was either generated at step 403 or selected at step 407 (step 410). Generally, this means that the query engine retrieves selective database records according to the query execution strategy, and evaluates the logical query conditions with respect to the selected record in an order determined by the strategy, using any known technique or technique hereafter developed. E.g., for a conjunction of logical ANDs, each successive condition is evaluated until a condition returns “false” (which obviates the need to evaluate any further conditions) or until all conditions are evaluated.

The query engine then generates and returns results in an appropriate form (step 411). E.g., where a user issues an interactive query, this typically means returning a list of matching database entries for display to the user. A query from an application program may perform some other function with respect to database entries matching a query.

Approximately concurrently with returning results to the requester, database management system 211 updates historical data in the query object to reflect the results of the query just executed (step 412). Specifically, the database management system updates the counts of number of executions 318 and cumulative cost 319. The database management system further compares the cost of the just completed query execution instance with the previously saved N worst case cost instances, and if the cost of the just completed query is greater than any of the saved N worst cases, the array of saved N worst cases 320 is updated by deleting the Nth instance and inserting the just completed query execution instance at an appropriate location in the array. The environmental variables and the imported variables of the just completed query are also saved in array 320.

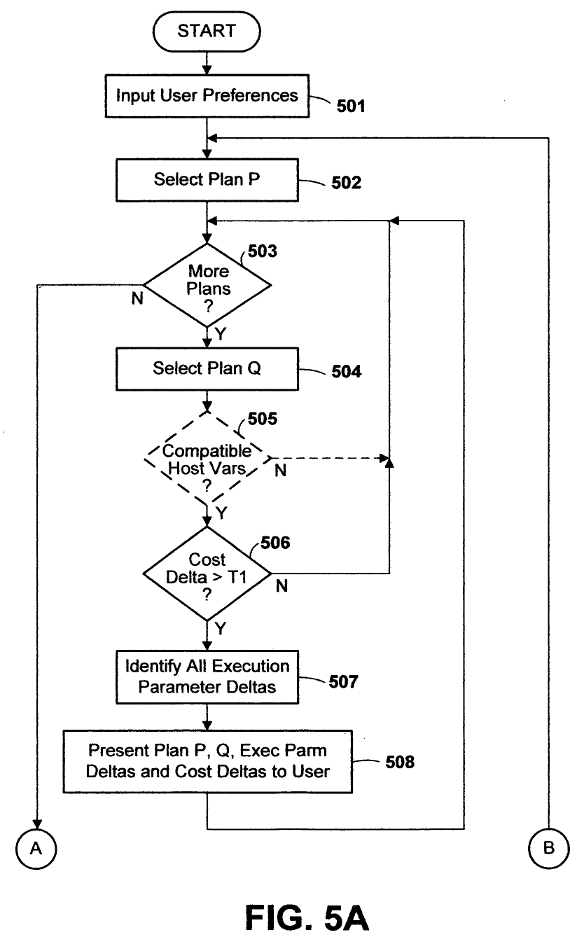

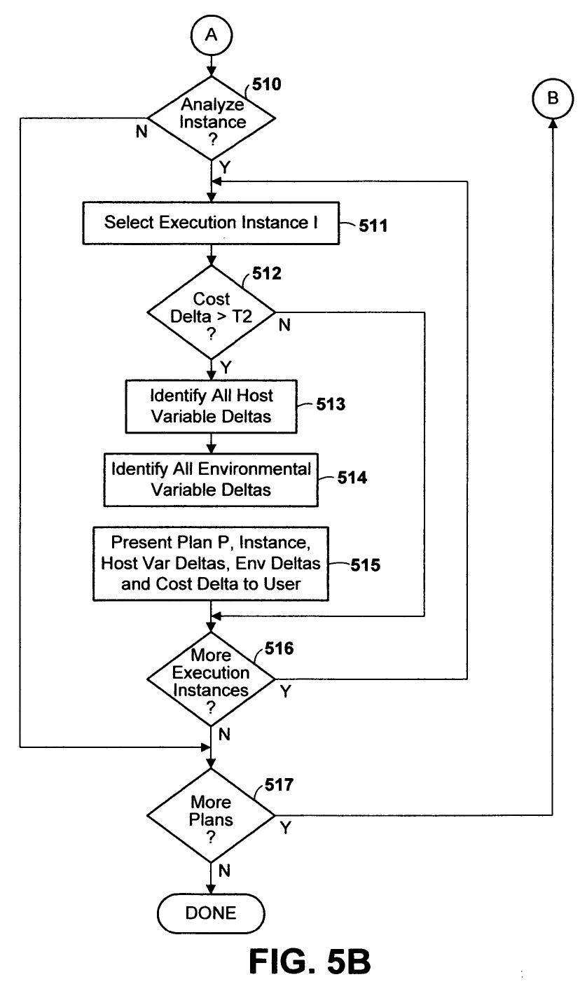

FIGS. 5A and SB (herein collectively referred to as FIG. 5) are a flow diagram showing the process of analyzing historical data to identify the effect of different imported variable values and/or environmental parameters on query execution performance, according to the preferred embodiment. Referring to FIG. 5, a user invokes the query strategy analyzer 216 and inputs any required user preferences for performing an analysis of historical data (step 501). User preferences might include, for example, any or all of: a logical query to be analyzed; whether historical data with respect to all execution strategies of the query is to be analyzed, or some subset of execution strategies (or even a single strategy); restrictions of imported variable values to be considered; whether some subset of environmental parameters is to be considered; any thresholds that are to be used in identifying deviations to be noted; etc.

Analysis begins by selecting an execution strategy (“plan”) P to be analyzed (step 502). The strategy is first analyzed by comparing its historical performance results to those of other strategies. If any more strategies (“plans”) remain to be compared with the selected strategy P, the ‘Y’ branch is taken from step 503, and a next strategy Q is selected for comparison with strategy P (step 504). It will be noted that the range of strategies selected at step 504 could be limited by user preferences input at step 501, i.e., a user might specify that only strategies meeting some criterion be selected, but in the default case all strategies are selected in turn. Generally, step 502 is executed to select each strategy in the plan cache in turn; however, a user could specify at step 501 that only some subset of strategies is to be analyzed, and in particular could specify that a single designated strategy P by chose for analysis.

In one optional variation of the preferred embodiment, if the strategy Q does not use the same or compatible imported (host) variables, then the ‘N’ branch is taken from step 505 and strategy Q is not analyzed further. As is well known, the value of an imported variable can significantly affect the cost of query execution. For example, a particular value of variable V may occur very rarely in the records, while another value is prevalent. If a query instance specifies the rarely occurring value, and an index is available to find the few records containing that value, it is possible that the query can execute relatively quickly compare with an instance of the same query which imports a different value of variable V. The effect of different host variable values on execution performance can be so large as to drown out the effect of other variations, such as variations in environmental parameters. For this reason, it may be unproductive in some circumstances to compare execution performance of strategies using different imported variables. Step 505 is therefore intended to remove from further consideration those strategies which use different or incompatible imported variables, which might be particularly useful when attempting to identify the effect of variations in environmental parameters alone. “Incompatible” might be something which is defined by the user at step 501. The user may choose to insist on strict equality of all imported variables, but may alternatively define certain imported variable values to be considered equivalent for purposes of step 505, or define some other test of “compatibility”.

If the strategy Q uses the same or compatible imported variables as strategy P, or if optional step 505 is not performed, the analyzer proceeds to step 506. The analyzer then computes a cost delta between strategies P and Q. The cost delta could be computed as a simple difference between the average cost of execution using strategies P and Q, could be computed as a percentage, or some other measure. If the delta does not exceed some pre-defined threshold T1, then the difference in execution performance is deemed insufficient for further analysis and presentation to the user, and the ‘N’ branch is accordingly taken from step 506. The threshold T1 could be a user-defined value which is input at step 501. There could also be multiple thresholds using different respective measures of cost.

If the ‘Y’ branch is taken from step 506 (the cost delta exceeds threshold T1), the analyzer compares the imported variable and environmental variable values 316 for which strategy P was originally constructed and optimized with the corresponding environmental variable values for which strategy Q was constructed and optimized, and identifies all differences between imported and environmental variable values (step 507). The analyzer then presents these results to the user (step 508). Preferably, the analyzer presents at least the imported and/or environmental values which are different and the resultant respective execution costs, although other data could be presented as well. Presenting results to the user could mean displaying results on an interactive display in any appropriate form, printing results on a hardcopy output, storing results in an electronic data file in system 100, transmitting results in electronic form over a network to another computer system, or any other means of communicating results to a user (including saving results for later communication to a user), and could include combinations of the above. The analyzer then returns to step 503 to find and select another strategy Q for comparison with strategy P. When done selecting strategies Q for comparison to strategy P, the ‘N’ branch is taken from step 503.

The analyzer may optionally further consider imported variable and/or environmental variable variations within particular execution instances of strategy P. Preferably, this option would be specified by the user at step 501. If variations within particular instances of strategy P are to be analyzed, the ‘Y’ branch is taken from step 510 to step 511; otherwise, the ‘N’ branch is taken, and steps 511-516 are by-passed.

To analyze execution instances of strategy P, the analyzer selects one of the N worst case saved instances I from array 320 (step 511). It computes a cost delta between the average cost of strategy P and the cost of the selected execution instance I, and compares it to a threshold T2 (step 512). This comparison is similar to that described above with respect to step 505, and the threshold T2 could be, but need not be, the same as threshold T1. If the delta does not exceed T2, then the difference in execution performance is deemed insufficient for further analysis and presentation to the user, and the ‘N’ branch is accordingly taken from step 512 to step 516, by-passing steps 513-515.

If the cost delta is exceeded (the ‘Y’ branch from step 512), the analyzer compares the imported (host) variable values for execution instance I with the original host variable values for which strategy P was optimized, and identifies any differences (step 513). The analyzer further compares all environmental variable values for execution instance I with the original environmental variable values for which strategy P was optimized, and identifies any differences (step 514). The analyzer then presents these results to the user (step 515). Presenting results to the user could use any of the techniques described above with respect to step 508. Preferably, the analyzer presents the imported variable differences, if any, the environmental differences, if any, and the cost deltas or other measure of cost. Additional data could also be presented to identify an execution instance.

If any more execution instances of strategy P remain to be analyzed, the ‘Y’ branch is taken from step 516, and a next instance is selected at step 511. When all instances have been considered, the analyzer proceeds to step 517. If, at step 517, any more applicable strategies remain to be selected as a plan P for analysis, the ‘Y’ branch is taken to step 502, and another plan P is selected. When all strategies have thus been analyzed, the analysis is complete. Depending on user-specified scop of the analysis, step 517 might continue the process until all strategies in the query object have been analyzed, or might analyze only some subset of strategies (which could be a single strategy).

Although the above process has been described generally to examine both variations in imported variable values and in environmental parameters, it will be understood that the analyzer could alternatively examine only imported variable values or only environmental parameters, and that such an alternative implementation might be a designed as a fixed limitation on the scope of the analysis performed by analyzer 216, or might be a user-specified parameter of analysis performed by analyzer 216.

As the process of identifying variations in imported variables and environmental parameters is described above, different execution strategies or different instances of the same execution strategy are compared from a common plan cache. However, a plan cache is just a collection of data which changes over time. It may alternatively be desirable to compare data from different data collections, specifically, from different snapshots of the plan cache. A “snapshot” of a plan cache is simply a plan cache state at a particular time which is frozen and preserved as a separate data entity from the plan cache itself, the plan cache itself being continually updated. By comparing different snapshots of a plan cache, or a snapshot from a previous time to the current plan cache state, useful information concerning changes to the database and execution performance over time may be obtained. Preferably, a comparison of different snapshots would be made by identifying a strategy (plan) P from a first snapshot, and a strategy P′ from a second snapshot, and comparing the differences as described above. In comparing differences between two snapshots containing the same plan, it would further be possible to compare the N worst case instances of strategy P from the first snapshot with the N worst case instances of strategy P′ from the second snapshot. Preferably, only matching strategies (pairs of strategies which are the same) are compared in order to focus on changes occurring over time, although it would alternatively be possible to compare pairs of strategies which do not match.

Among the advantages of the technique described herein as a preferred embodiment is the relatively low overhead of implementation and maintenance in that it generally uses information which is already available and maintained by the database for other purposes. I.e., the information in the strategy blocks is used generally by the database management system to select an appropriate strategy for executing a query instance and to determine when to generate a newly optimized strategy. The technique described herein uses this readily available data to provide useful analytical information to the user. This understanding can be useful for a variety of purposes. For example, the user might be able to alter environmental parameters for future queries in such a way as to improve query execution performance. The user might be able to re-formulate queries, define metadata structures, or take some other action to optimize performance in the presence of data skew. The user may even alter database definitions.

In the embodiment described herein, historical data has generally been described, for clarity of description and illustration, as cumulative data which is equally weighted regardless of age. However, as is well known, the characteristics of certain databases change over time due to accumulation of more records, changes to business enterprises, personnel, customers, services, and so forth which the database reflects, changes to the underlying computer system or systems, and various other factors. Historical data may be aged using any of various aging techniques. For example, historical data may be accumulated in time intervals, where data from intervals exceeding a certain age may be periodically purged, this being but one of many possible aging techniques.

In the preferred embodiment described above, the generation and execution of the query, and the analysis of query historical data, is described as a series of steps in a particular order. However, it will be recognized by those skilled in the art that the order of performing certain steps may vary, and that variations in addition to those specifically mentioned above exist in the way particular steps might be performed. In particular, the manner in which queries are written, parsed or compiled, and stored, may vary depending on the database environment and other factors.

In general, the routines executed to implement the illustrated embodiments of the invention, whether implemented as part of an operating system or a specific application, program, object, module or sequence of instructions, are referred to herein as “programs” or “computer programs”. The programs typically comprise instructions which, when read and executed by one or more processors in the devices or systems in a computer system consistent with the invention, cause those devices or systems to perform the steps necessary to execute steps or generate elements embodying the various aspects of the present invention. Moreover, while the invention has and hereinafter will be described in the context of fully functioning computer systems, the various embodiments of the invention are capable of being distributed as a program product in a variety of forms, and the invention applies equally regardless of the particular type of signal-bearing media used to actually carry out the distribution. Examples of signal-bearing media include, but are not limited to, volatile and non-volatile memory devices, floppy disks, hard-disk drives, CD-ROM's, DVD's, magnetic tape, and so forth. Furthermore, the invention applies to any form of signal-bearing media regardless of whether data is exchanged from one form of signal-bearing media to another over a transmission network, including a wireless network. Examples of signal-bearing media are illustrated in FIG. 1 as system memory 102, and as data storage devices 125-127.

Although a specific embodiment of the invention has been disclosed along with certain alternatives, it will be recognized by those skilled in the art that additional variations in form and detail may be made within the scope of the following claims:

What is claimed is:

1. A method for analyzing execution performance of database queries in at least one computer system, comprising the computer-executed steps of:
executing a plurality of execution instances of a logical query against data in a database of said at least one computer system;
maintaining historical data with respect to query execution performance of said plurality of execution instances of said logical query, said historical data including historical data concerning query execution performance under differing values of at least one execution parameter;
analyzing said historical data to identify an affect of at least one execution parameter on query execution performance, said at least one execution parameter comprising at least one from the set consisting of: (a) an environmental parameter; and (b) an imported variable value; and
presenting results of said analyzing step to a user.

2. The method for analyzing query execution performance of claim 1,
wherein said maintaining step comprises maintaining respective historical data for each query execution strategy of a plurality of query execution strategies for executing said logical query, said historical data including one or more respective execution parameter values associated with each said query execution strategy.

3. The method for analyzing query execution performance of claim 2, wherein said analyzing step comprises comparing said one or more respective execution parameter values associated with each of a plurality of different said query execution strategies.

4. The method for analyzing query execution performance of claim 1, wherein said maintaining step comprises maintaining a plurality execution parameter sets, each execution parameter set comprising a respective value of at least one execution parameter, each execution parameter set being associated with a respective execution performance data set, each execution performance data set comprising data representing execution performance of a respective subset of said plurality of execution instances.

5. The method for analyzing query execution performance of claim 4, wherein each of a plurality of said subsets of said plurality of execution instances comprises a respective one or more execution instances of a common query execution strategy, and wherein said analyzing step comprises comparing execution parameter sets and corresponding execution performance data sets representing execution performance of execution instances of said common query execution strategy.

6. The method for analyzing query execution performance of claim 4, wherein each of a plurality of said subsets of said plurality of execution instances comprises a subset representing all execution instances of a respective query execution strategy of a plurality of different query execution strategies, and wherein said analyzing step comprises comparing execution parameter sets and corresponding execution performance data sets representing execution performance of execution instances of respective different query execution strategies.

7. The method for analyzing query execution performance of claim 1, wherein said maintaining step comprises capturing at least one snapshot representing a state of said historical data at a particular time, and wherein said analyzing step comprises comparing historical data from a first said snapshot with at least one of: (a) a second snapshot, and (b) a current state of said historical data.

8. The method for analyzing query execution performance of claim 1, wherein said at least one execution parameter includes at least one environmental parameter.

9. The method for analyzing query execution performance of claim 8, wherein said at least one environmental parameter includes at least one configuration parameter of said computer system.

10. The method for analyzing query execution performance of claim 1, wherein said at least one execution parameter includes at least one imported variable value.

11. A computer program product for analyzing execution performance of database queries, comprising:
a plurality of computer-executable instructions recorded on signal-bearing media, wherein said instructions, when executed by at least one computer system, cause the at least one computer system to perform the steps of:
receiving historical data with respect to query execution performance of a plurality of execution instances of a logical query against data in a database, said historical data including historical data concerning query execution performance under differing values of at least one execution parameter;
analyzing said historical data to identify an affect of said at least one execution parameter on query execution performance, said at least one execution parameter comprising at least one from the set consisting of: (a) an environmental parameter; and (b) an imported variable value; and
presenting results of said analyzing step to a user.

12. The computer program product of claim 11, wherein said historical data comprises respective historical data for each query execution strategy of a plurality of query execution strategies for executing said logical query, said historical data including one or more respective execution parameter values associated with each said query execution strategy; and
wherein said analyzing step comprises comparing said one or more respective execution parameter values associated with each of a plurality of different said query execution strategies.

13. The computer program product of claim 11,
wherein said historical data comprises a plurality execution parameter sets, each execution parameter set comprising a respective value of at least one execution parameter, each execution parameter set being associated with a respective execution performance data set, each execution performance data set comprising data representing execution performance of a respective subset of said plurality of execution instances.

14. The computer program product of claim 13,
wherein each of a plurality of said subsets of said plurality of execution instances comprises a respective one or more execution instances of a common query execution strategy, and wherein said analyzing step comprises comparing execution parameter sets and corresponding execution performance data sets representing execution performance of execution instances of said common query execution strategy.

15. The computer program product of claim 13,
wherein each of a plurality of said subsets of said plurality of execution instances comprises a subset representing all execution instances of a respective query execution strategy of a plurality of different query execution strategies, and wherein said analyzing step comprises comparing execution parameter sets and corresponding execution performance data sets representing execution performance of execution instances of respective different query execution strategies.

16. The computer program product of claim 11, wherein said at least one execution parameter includes at least one environmental parameter.

17. The computer program product of claim 11, wherein said at least one execution parameter includes at least one imported variable value.

18. A computer system, comprising:
at least one processor;
a data storage for storing a database, said database containing at least one database table;
a database management facility embodied as a plurality of instructions executable on said at least one processor, said database management facility executing queries against data in said database and maintaining historical data with respect to query execution performance, said historical data comprising, for each of a plurality of logical queries, a respective set of historical data concerning query execution performance of a plurality of execution instances of the respective logical query under differing values of at least one execution parameter;
an analyzer function embodied as a plurality of instructions executable on said at least one processor, said analyzer analyzing said historical data to identify an affect of at least one execution parameter on query execution performance, said at least one execution parameter comprising at least one from the set consisting of: (a) an environmental parameter; and (b) an imported variable value, said analyzer further presenting results of said analysis to a user.

19. The computer system of claim 18, wherein said analyzer function is separate from said database management facility.

20. The computer system of claim 18,
wherein each said set of historical data comprises a plurality execution parameter sets, each execution parameter set comprising a respective value of at least one execution parameter, each execution parameter set being associated with a respective execution performance data set, each execution performance data set comprising data representing execution performance of a respective subset of said plurality of execution instances of the respective logical query to which the set of historical data corresponds; and
wherein each of a plurality of said subsets of said plurality of execution instances of the respective logical query comprises a respective one or more execution instances of a common query execution strategy of the respective logical query, and wherein said analyzer function compares execution parameter sets and corresponding execution performance data sets representing execution performance of execution instances of said common query execution strategy.

21. The computer system of claim 18,
wherein each said set of historical data comprises a plurality execution parameter sets, each execution parameter set comprising a respective value of at least one execution parameter, each execution parameter set being associated with a respective execution performance data set, each execution performance data set comprising data representing execution performance of a respective subset of said plurality of execution instances of the respective logical query to which the set of historical data corresponds; and
wherein each of a plurality of said subsets of said plurality of execution instances of the respective logical query comprises a subset representing all execution instances of a respective query execution strategy of a plurality of different query execution strategies, and wherein said analyzer function compares execution parameter sets and corresponding execution performance data sets representing execution performance of execution instances of respective different query execution strategies.
